(19) United States
(12) Patent Application Publication
(10) Pub. No.: US 2023/0386068 A1
(43) Pub. Date: Nov. 30, 2023

(54) Determining the Module Size of an Optical Code

(71) Applicant: SICK AG, Waldkirch (DE)

(72) Inventors: Romain MÜLLER, Waldkirch (DE); Pascal SCHÜLER, Waldkirch (DE)

(21) Appl. No.: 18/134,366

(22) Filed: Apr. 13, 2023

(30) Foreign Application Priority Data
May 31, 2022 (EP) 22176561.3

(51) Int. Cl. G06T 7/62; G06K 7/14; G06T 5/40; G06T 7/11; G06V 10/28; G06V 10/74

(52) U.S. Cl. CPC G06T 7/62; G06K 7/1456; G06T 5/40; G06T 7/11; G06V 10/28; G06V 10/761; G06T 2207/20084

(57) ABSTRACT

A method of determining the module size of an optical code (20) is specified in which image data having the code (20) are recorded and the module size is estimated from distances between light-dark transitions in the image data, At least one frequency distribution, in particular a histogram, is formed that indicates how often dark and/or light pixel sequences of a respective number occur along at least one line through the code (20) and the module size is estimated from the frequency distribution.

The invention relates to a method of determining the module size of an optical code and to a code reader in accordance with the preamble of claims 1 and 15 respectively.

Code readers are known from supermarket checkouts, for automatic parcel identification, for sorting mail shipments, from baggage handling at airports, and from other logistics applications. In a code scanner, a reading beam is guided transversely over the code by means of a rotating mirror or by means of a polygon mirror wheel. A camera-based code reader records images of the objects having the codes located thereon with the aid of an image sensor and image evaluation software extracts the code information from these images. Camera-based code readers also cope without problem with different code types than one-dimensional barcodes which also have a two-dimensional structure like a matrix code and provide more information.

In an important application group, the objects bearing the code are conveyed past the code reader. A code scanner here detects the respective codes successively led into its reading zone. Alternatively, in a camera based code reader, a line scan camera reads in the object images having the code information successively and linewise with the relative movement. As a rule, image data are recorded using a two-dimensional image sensor that overlap more or less depending on the recording frequency and on the conveying speed. So that the objects can be arranged in any desired orientation on the conveyor, a plurality of code readers are often provided at a reading tunnel to record objects from a plurality of sides or from all sides.

The image data are preferably already pre-processed directly, on the fly, in an FPGA (field programmable gate array) and in this respect additional information or metadata can be saved together with the image data for a further processing microprocessor. Typical pre-processing steps relate to the binarization by which a grayscale image becomes a black and white image or to the segmentation in which regions of interest (ROIs) having code candidates are located. EP 2 003 599 A1 thus describes an optoelectronic sensor and a method for the detection of codes in which a binarizer is already configured for a conversion of a color image or a grayscale image into a binary image during the reception and/or in real time in that a respective read section is binarized even while the further sections are read in. EP 2 555 160 B1 locates regions of interest or code candidates using a contrast measure in a pre-processing on an FPGA. In EP 3 916 633 A1, first layers of a neural network are already run through for segmentation during the reading on an FPGA. EP 1 365 577 A1 discloses a method of operating an optoelectronic sensor in which an image is already compressed during the reception. In this respect, the capability of the FPGA is respectively used to carry out a number of simple processing operations such as matrix multiplications in parallel in real time. Sequential, more complex processing operations such as those of a decoder for reading optical codes are reserved for a microprocessor that makes use of the provided image data and possible pre-processing results for this purpose.

A characteristic size of an optical code is the module size. A module is the smallest element of the code and the code elements or characters are composed of one or more modules. The module size is a measure for the extent of the module and is specified in pixels per module (ppm). A bar in a barcode thus has a width that corresponds to a single or multiple module size and this applies analogously to the two dimensions of a dark or light field in a two-dimensional code. A large module size means that the code has been detected with high resolution in the image data or grayscale profiles. The decoding consequently becomes all the more challenging the smaller the module size is, particularly if it reaches a range of two or even fewer ppm.

It would be an advantage if the decoder were to already be aware of a good estimation initially, above all in the case of small module sizes. Measures could namely then be taken to also read the low resolution code. An example is so-called super-resolution. Methods are meant by this that combine a plurality of low resolution images into one higher resolution image. Conversely, a complex decoding process for a code that is anyway detected at high resolution with a large module size can possibly be dispensed with. It is generally helpful for reading success of the decoder to be aware of parameters characterizing the code, such as the module size here, beforehand. The parameter space of the decoder can be ideally set in this manner, but only when the module size is available in good time.

In fact, however, the module size is only known in retrospect after a successful decoding process in conventional methods. Which characters the code contains is then clear and the module size is then also calculable with great accuracy using the total size of the code in the image data. With a barcode, for example, the total number of modules between the start and stop patterns is determined using the characters and the extent of the code in pixels is divided by this total number. The module size is thus a result of the decoding and not a support for it.

In principle, the module size is nothing but the smallest distance between two edges of the recorded grayscale profile. Such edges, that is transitions between the light and dark code elements, can be located by the extremes in the derivation of the grayscale profile. The result, however, is sensitively dependent on how precisely the edge positions have been localized. This is in particular difficult with very small module sizes since the edge positions are initially only present in discrete form and thus not exact to the subpixel. In addition, the edge positions are very susceptible to noise. A process based purely on edges is already in principle a binarization with which the original grayscale information is reduced from as a rule eight bits or even more to only one bit and this information loss also limits the possible accuracy of the determination of the module size.

U.S. Pat. No. 5,053,609 determines the physical extent of a 2D code. An alternating sequence of light and dark code elements is arranged at its margin that are counted to determine the information density. The module size can be reconstructed from this, but only when the alternating code elements are present at the margin and have been detected as such in a countable manner.

Generating a grayscale histogram of the image data is known in the field of code reading. However, this is typically used for completely different purposes, for example to obtain or to emulate a more uniform illumination or to determine a suitable binarization threshold. EP 3 789 906 A1 uses a grayscale histogram to determine the module size.

It is therefore the object of the invention to provide an improved possibility of determining the module size.

This object is satisfied by a method of determining the module size of an optical code and by a code reader in accordance with claims 1 and 15 respectively. The steps of determining the module size and also the further optional steps such as those to read a barcode run automatically; it is a computer implemented process. The optical code can be a barcode, but also a two-dimensional code in accordance with one of the various known standards. In this description, the term barcode is used synonymously with a one-dimensional optical code, contrary to some of the literature that also sometimes calls two-dimensional codes barcodes.

Image data are generated that contain the code and that are preferably at least roughly tailored to the code zone. Image data are typically recorded by an image sensor of a camera based code reader, but the intensity profile of a barcode scanner is here also covered by the term image data. The image data are preferably on a pixel grid having m×n pixels that is recorded by a matrix sensor in one recording or alternatively successively in a plurality of rows strung together. The module size is determined from the distances between light/dark transitions in the image data. This means transitions in both directions from light to dark or from dark to light that define edges between the code elements.

The invention starts from the basic idea of forming a frequency distribution of the widths of light and dark zones occurring in the image data. The sequence of pixels along at least one line through the code is evaluated for this purpose, with a count respectively being made of how many light pixels follow on from one another or how many dark pixels follow on from one another. The length of such a pixel sequence corresponds to the distance between two light/dark transitions or edges in the image data; a respective pixel sequence starts at one edge and ends at the next edge along the line. In other words, the frequency distribution counts how many light or dark single pixels, two-rows up to n rows of pixels of the same brightness class there are, that is dark or light pixels. The line along which the consecutive pixels are strung along is preferably straight; it can alternatively be deliberately curved to follow a non-planar code substrate, for example. The larger a code element the line respectively sweeps over is, the longer the pixel sequences of a brightness class are. The frequency distribution thus collects all the pixel sequences that occur. The information on the module size is therefore contained multiple times in the frequency distribution and can be statistically estimated in this manner.

Since the data underlying the frequency distribution are pixels, it is inherently a discrete frequency distribution that can be described by a histogram. The term histogram is therefore frequently used as representative for the frequency distribution in this description. It is, however, thus not precluded that the discrete description plane is left and, for example, an originally discrete frequency distribution is replaced with or approximated by a smooth function, for instance to continue the evaluation analytically, for example. The histogram can descriptively be called a width histogram since a count is made in the bins as to how often a stringing together of dark or light pixels of a respective number occurs along the line and this number corresponds to the width of the code element in the line direction. It must be emphasized as a precaution that the frequency distribution determined in accordance with the invention is not a brightness distribution or not a grayscale histogram as in the quoted prior art discussed in the introduction.

The invention has the advantage that a simple and fast calculation of the module size is made possible that can take place in very early phases of the image processing chain and in particular does not require any successful decoding. The method is particularly suitable in a split architecture with pre-processing, for example by an FPGA and a subsequent decoding using metadata of the pre-processing, in a microprocessor for example. The microprocessor can estimate the module size using the metadata, preferably metadata in the form of the frequency distribution, without itself having to again access the image data in a time-consuming manner for this purpose. A large module size will generally be estimated better. With small module sizes, an exact result is very much more difficult to detect due to washed out effects and the like. However, the information that it is a small module size without any more precise quantification is already of great value for the further procedure for decoding. Finally, the acquisition of additional information is possible by the method in accordance with the invention; for example, the value of a barcode that enables a direct selection of decoding algorithms suitable for this purpose or the exact orientation of the code with respect to the pixel grid of the image data.

A dark frequency distribution is preferred for dark pixel sequences and a light frequency distribution for light pixel sequences. Dark frequency distribution and bright frequency distribution are here only to be understood as names of the corresponding frequency distributions. The frequencies are separately detected and evaluated for the two possible dark and light code elements, in particular the bars and spacings with barcodes. This produces a wider information base and exact results. The estimation of the module size is based on both frequency distributions, with various variants being possible. The more suitable of the two frequency distributions can be located and the others discarded; both frequency distributions can be evaluated and the results compared or combined; and in the simplest case the frequencies of the two frequency distributions can be added up to thus combine them into one single frequency distribution.

A horizontal frequency distribution along at least one horizontal line and a vertical frequency distribution along at least one vertical line are preferably formed. They are two different, separate frequency distributions than the dark frequency distribution and the light frequency distribution. Both divisions can be combined; there are then four frequency distributions from the combinations dark and light and horizontal and vertical. Despite the terms horizontal and vertical, the demand on the horizontal line and on the vertical line is initially weaker; they can extend obliquely and at a different angle than perpendicular to one another. However, they are preferably actually at least mutually perpendicular and even more preferably horizontal and vertical lines in the geometrical sense that follow the rows and columns. The pixel access along the lines is then particularly simple and discretization artifacts of oblique lines over a discrete grid are then avoided.

Further steps with respect to the frequency distribution will be explained multiple times in the following. This means the single frequency distribution, at least one frequency distribution, a plurality of or all of the frequency distributions are thus then formed in dependence on the respective embodiment.

An orientation of the code in the image data is preferably determined by a comparison of a first estimate of the module size from the horizontal frequency distribution and a second estimate of the module size from the vertical frequency distribution. The orientation describes the angle at which the code elements and specifically bars are rotated with respect to the pixel grid. Depending on the orientation, code elements of objectively the same extent along the horizontal line and the vertical line appear to have different widths; the two horizontally and vertically estimated module sizes differ from one another. The orientation can be backcalculated from the difference. The ratio, a quotient formation, with a calculation of a trigonometric function thereof are in particular suitable as a comparison. The orientation can very specifically be calculated as a tangent of the quotient of the module size determined along a horizontal line and of the module size determined along a vertical line.

The module size is preferably corrected by an orientation of the codes in the image data. A trigonometric function is again suitable for this, in particular the cosine of the orientation as a correction factor. The orientation is preferably determined as described in the previous paragraph, but the information on the orientation can also be acquired in any desired very different manner. Since how many pixels are available in the specific grayscale profile to be evaluated per smallest code element is decisive for the decoding of a code, a correction of the module size is not absolutely necessary. The relative module size with respect to the selected lines can have greater informative value for the decoding success than a corrected absolute module size.

The at least one frequency distribution is preferably formed along a plurality of mutually parallel lines through the code. The statistics of the frequency distribution are thereby increased and a more robust result is thus achieved since every further parallel line enables the counting of further pixel sequences with information on the same module size. A plurality of or even all the rows or columns of the pixel grid are preferably evaluated.

The at least one frequency distribution preferably takes account of pixel sequences of a number greater than a maximum threshold. In other words, the frequency distribution beyond the maximum threshold is cut off with pixel frequencies that are too long, whether as part of the evaluation of the frequency distribution or already on its generation. This is based on the assumption that such long pixel sequences no longer correspond to code elements, but rather to homogeneous background surfaces.

Only frequencies above a minimum threshold are preferably taken into account in the at least one frequency distribution. Only significant frequencies thus remain. If a specific length of a pixel sequence only occurs once or a few times up to the minimum threshold, this is considered an outlier and the frequency distribution at this point is no longer considered in the further evaluation; for example, this frequency is set to zero. If there are no frequencies above the minimum threshold in the total frequency distribution, no meaningful determination of the module size is possible herewith, for example due to strong blur or to a module size far below the optical resolution, and the further evaluation can be aborted. The line along which the frequency distribution is formed possibly runs in parallel with the bars of a barcode. It is conceivable that a determination of the module size is successful along a different line with a different orientation. There is otherwise possibly no code in the image data at all and even if there is, it must be anticipated that this code will not be legible. The decision on whether decoding attempts will be performed without determining the module size can, however, also take place on the basis of different criteria at a different point.

The module size is preferably determined from a position of a first maximum in the at least one frequency distribution. The module size corresponds to the smallest code element and thus to the first cluster of pixel sequences of a smallest length, i.e. to the first maximum or peak. The maximum can be localized in all the manners known per se, for example via a threshold, a function fit or parabola fit, and the like. Particularly preferred embodiments with template matching or methods of machine learning will be described further below. The module size determined in this manner is, as already explained, dependent on the orientation of the line via which the frequency distribution is formed.

A value of the code is preferably determined from the number and/or location of maxima in the at least one frequency distribution. The value designates over how many module sizes a code element extends at a maximum. With a barcode of a value of two, the bars are consequently one or two module sizes wide. The value corresponds to the number of maxima or peaks in the frequency distribution. There can here still be maxima that have been produced by interference effects or maxima can be too little pronounced to identify them as such. Plausibilizations are therefore conceivable, for instance using the required uniform distance. In another respect, the module size can also be confirmed again or corrected over the further peaks since the peaks are spaced apart from one another in the module size. If a plurality of frequency distributions having dark and light pixel frequencies or horizontal and vertical lines are determined, a plausibilization via a multiple evaluation is possible. The value of the code allows conclusions on the code type and thus a selection of likely suitable decoders.

The module size is preferably determined by a comparison of the at least one frequency distribution with reference frequency distributions for different classes of module sizes. The reference frequency distributions can be understood as templates and a frequency distribution is associated by template matching. There are, for example, reference frequency distributions for module sizes<1, [1, 1.5}, . . . , >5 in any desired steps or here preferably equal steps of 0.5. A finer gradation for small and large module sizes is not meaningful because all the conceivable improvements should anyway be offered for codes having module sizes below one and conversely codes with module sizes above five should be read very unproblematically. Said numerical values are sensible examples, but are nevertheless not fixed in this way. The reference frequency distributions generated in advance and the respective detected frequency distributions compared therewith are preferably standardized. Any desired correlation processes are suitable for comparing or template matching; they are two one-dimensional discrete curve series for which a large number of similarity criteria are known per se. In a particularly simple embodiment, the respective difference is formed between the frequency distribution to be compared and the different reference frequency distributions. The frequency distribution is associated with the reference frequency distribution having the smallest difference.

The module size is preferably determined by evaluating the at least one frequency distribution using a process of machine learning, in particular using a neural network. Such an evaluation is extremely powerful and highly flexible so that in many cases the correct module size is associated with unsuitable frequency distributions even for conventional processes such as a threshold evaluation. The neural network preferably has hidden layers (deep learning). The frequency distributions do not represent any all too complex data so that a small neural network having one or two hidden layers can suffice. There is a huge number of usable software packages available for neural networks and, where required, also dedicated hardware. The process of machine learning is preferably trained by supervised learning. A generalization to image data or frequency distributions detected later in operation is then made from a training dataset with training examples of a specified correct evaluation (annotation, labeling).

The process is preferably taught using training examples with image data or frequency distributions and associated module sizes. The reference frequency distributions for a template matching can be derived from these training examples or the process of machine learning or the neural network can be trained. Images with readable codes are preferably the basis for the training examples. The module size can be retrospectively reliably determined from a decoded code. This makes it possible to associate the training examples automatically and reliably with a class of reference frequency distributions or to annotate them for the supervised training of a process of machine learning. Training examples can thus be obtained in large numbers very simply from existing code reader applications. Alternatively or additionally, images having codes of a different code content and type can be artificially generated and also alienated.

The image data are preferably segmented in a pre-processing to locate an image zone having the code (region of interest, ROI). As described in the introduction, an FPGA is preferably responsible for this. The image data can be split into zones of a fixed size or tiles and tiles with, for example, high contrast can be compiled to form the ROIs. The generation of frequency distributions can take place per tile and frequency distributions of a plurality of tiles can subsequently be added up. Only the last step preferably takes place in a microprocessor that thus, for the determination of the module size, only still has to access metadata delivered by the FPGA, namely the frequency distributions with respect to the individual tiles and no longer the original image data.

The image data are preferably binarized. An unambiguous decision can thus already be made on dark and light in advance of the formation of frequency distributions. The binarization preferably remains restricted to ROIs and can already take place on the FPGA.

The optical code is preferably read after the determination of the module size. The determination of the module size is therefore an early step in the image processing or reading of the code and cannot access the results of the decoding. Very precise conventional alternative processes would also be available as described in the introduction for a determination of the module size after the decoding. A subsequently determined module size could, however, naturally not support the decoding.

The optical code is preferably read suing a decoding process selected with reference to the module size and/or parameterized by the module size. The module size is therefore a parameter that is available in the decoding and possibly already for further preparatory steps such as a fine segmentation of the code zones. The decoding and possibly the segmentation, in particular a fine segmentation, are supported, simplified, accelerated, improved, or made possible at all by the advance knowledge of the module size. One example is super-resolution, that is the generation of image data of a higher resolution from a plurality of sets of image data of a lower resolution. The module size can be an indication for which codes super-resolution is needed at all. In addition, the module size is also a very helpful parameter for a super-resolution algorithm. It is also conceivable, on the other hand, to carry out the determination of the module size in accordance with the invention only subsequent to a super-resolution algorithm, with then the scaling factor having to be taken into account for an absolute module size. A further example of the influence of the module size on the decoding is the knowledge that a decoding will not be possible at all because the module size is too small for the existing decoding processes. A practical limit for barcodes is currently at 0.6 ppm. It then saves resources to classify the code directly as unreadable with reference to the module size instead of first allowing various complex decoding processes to fail in a laborious manner because of it.

The module size is preferably only determined binarily as a small or larger module size, with in particular a small module size being below two or below one and a larger module size correspondingly amounting to at least two or at least one. As always in this description, module sizes are measured in the unit ppm (pixels per module). In this connection, larger module size is not to be understood as a vague numerical indication, but rather its binary opposite “not small” module size. The small module size can be the best result that the method in accordance with the invention is able to perform because the quality of the image data and frequency distributions does not permit any quantitative determination. It is also possible, on the other hand, to convert a quantitatively determined module size into small or larger by a comparison with a limit value. Small module sizes are particularly challenging for the decoder, for example, because only a complex super-resolution algorithm is used for this. A hard limit such as 0.6 ppm can also be set and a reading error can then be output directly for small module sizes without a decoding attempt.

The code reader in accordance with the invention for reading optical codes can be a barcode scanner, for example with a photodiode as a light reception element. It is preferably a camera based code reader with an image sensor as the light reception element. The image sensor can in turn be a line sensor for the detection of a code line or of an areal code image by assembling image lines or a matrix sensor, with recordings of a matrix sensor also being able to be joined together to form a larger output image. A network of a plurality of code readers or camera heads is likewise conceivable. A control and evaluation unit can itself be part of a barcode scanner or of a camera based code reader or can be connected thereto as a control unit. A method in accordance with the invention of determining the module size of an optical code and a preferably subsequent reading of the code using the now known module size is implemented therein.

The invention will be explained in more detail in the following also with respect to further features and advantages by way of example with reference to embodiments and to the enclosed drawing. The Figures of the drawing show in:

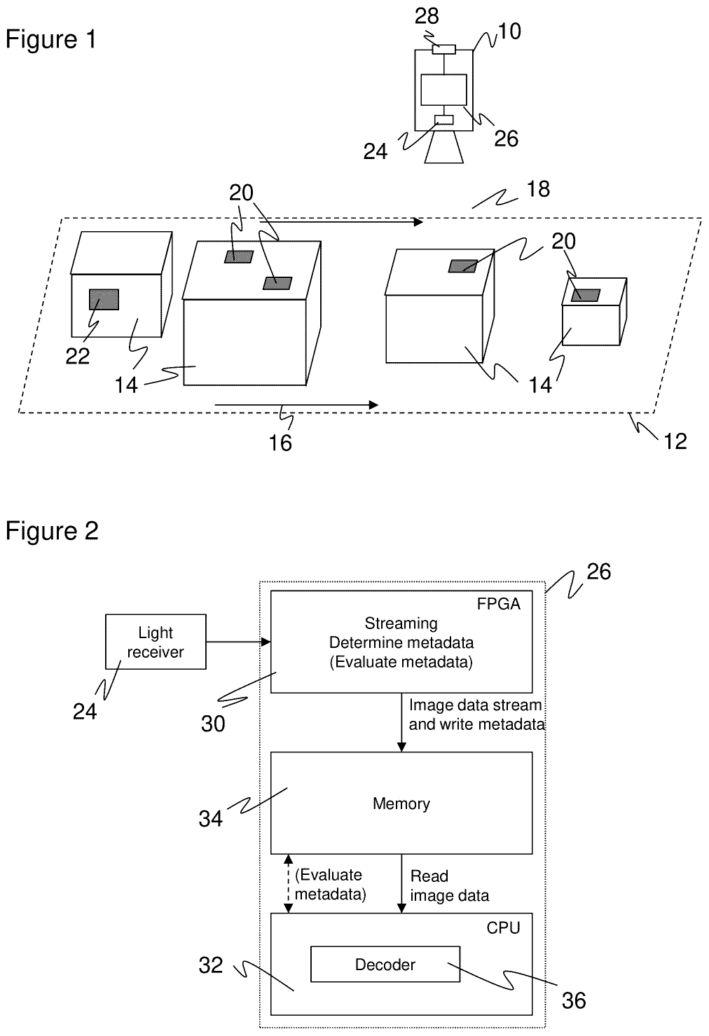

FIG. 1 a schematic three-dimensional overview representation of the exemplary installation of a code reader above a conveyor belt on which objects having codes to be read are conveyed;

FIG. 2 a schematic representation of a heterogeneous architecture for preprocessing with an FPGA and a CPU for a further processing or as a decoder;

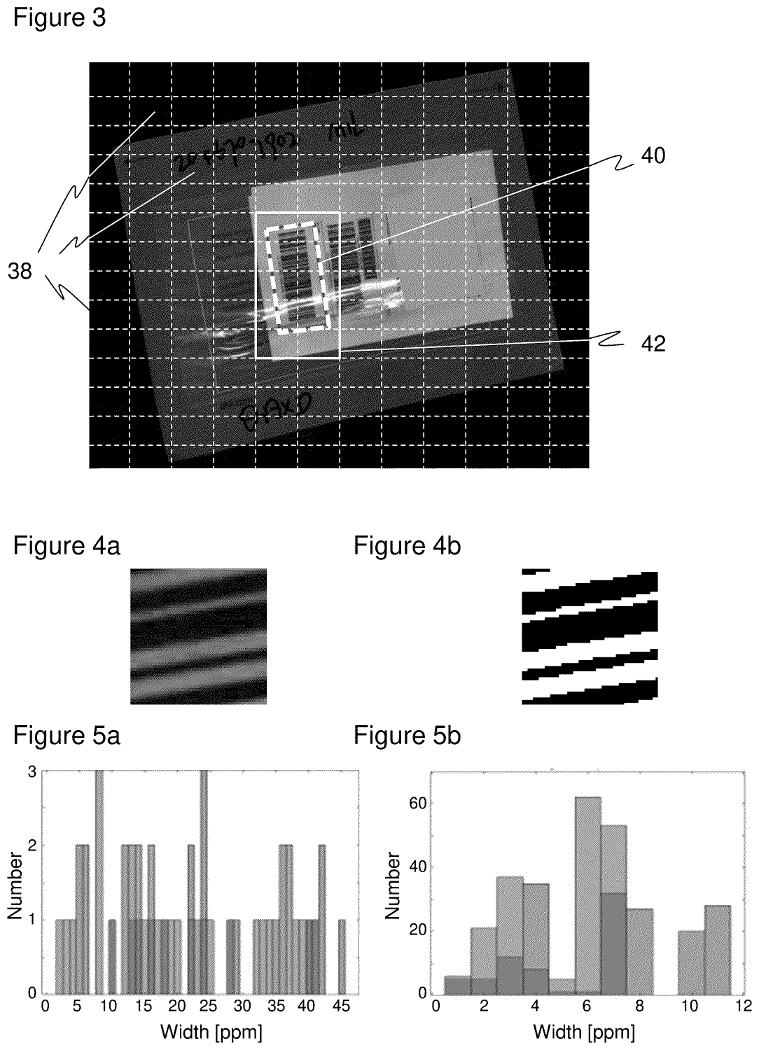

FIG. 3 an exemplary image with optical codes, a division into tiles, and a region of interest with an optical code;

FIG. 4a an exemplary tile with a portion of a code;

FIG. 4b the portion of a code in accordance with FIG. 4a after a binarization;

FIG. 5a a histogram with frequencies of horizontal light and dark pixel sequences of different lengths in the portion of FIG. 4b;

FIG. 5b a histogram with frequencies of vertical light and dark pixel sequences of different lengths in the portion of FIG. 4b;

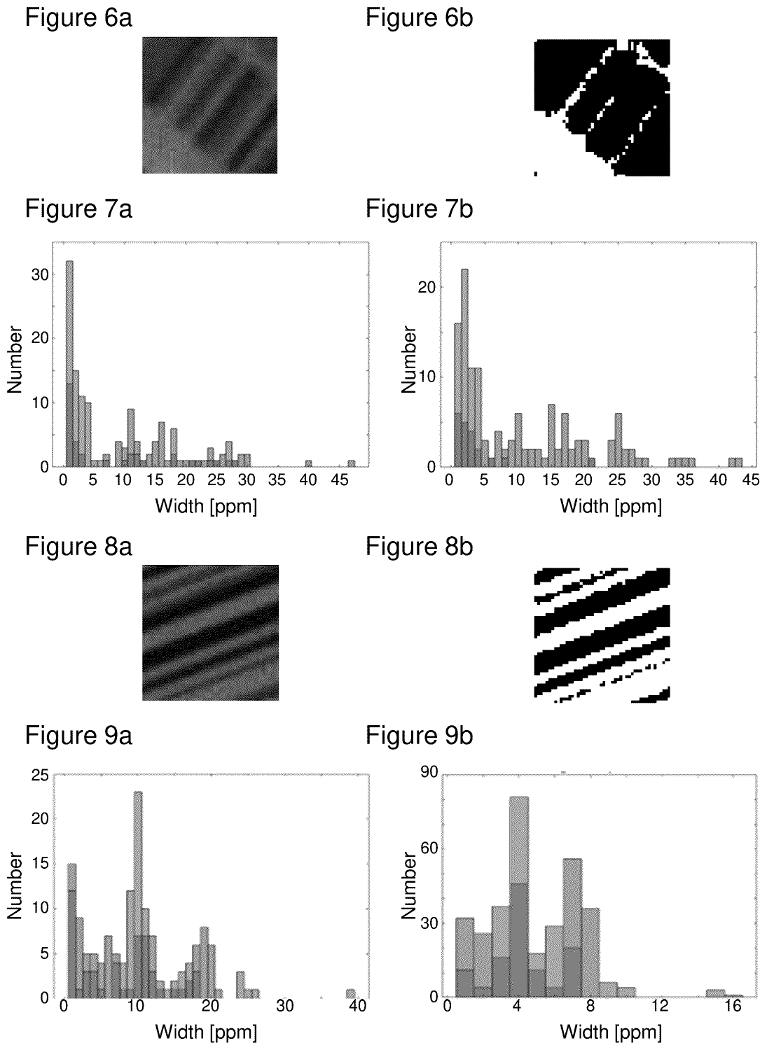

FIG. 6a an exemplary tile with a portion of a further small code recorded as blurred;

FIG. 6b the portion of a code in accordance with FIG. 6a after a binarization;

FIG. 7a a histogram with frequencies of horizontal light and dark pixel sequences of different lengths in the portion of FIG. 6b;

FIG. 7b a histogram with frequencies of vertical light and dark pixel sequences of different lengths in the portion of FIG. 6b;

FIG. 8a an exemplary tile with a portion of a further code;

FIG. 8b the portion of a code in accordance with FIG. 8a after a binarization;

FIG. 9a a histogram with frequencies of horizontal light and dark pixel sequences of different lengths in the portion of FIG. 8b;

FIG. 9b a histogram with frequencies of vertical light and dark pixel sequences of different lengths in the portion of FIG. 8b;

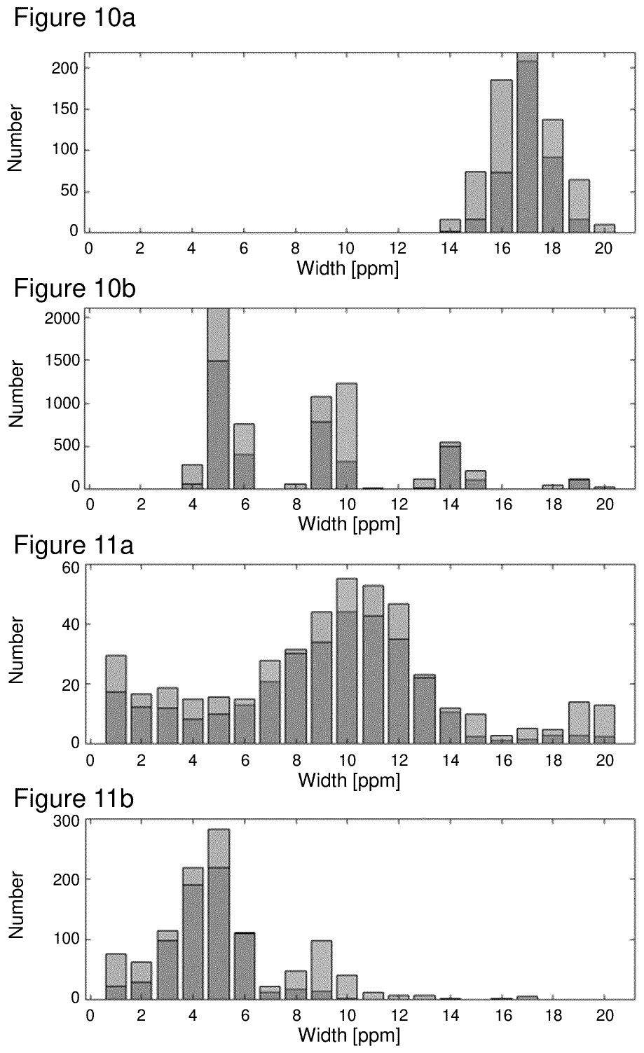

FIG. 10a a histogram with frequencies of horizontal light and dark pixel sequences of different lengths for a further code example, not shown, with a module size 2.31 ppm;

FIG. 10b a histogram with frequencies of vertical light and dark pixel sequences of different lengths for the code example of FIG. 10a;

FIG. 11a a histogram with frequencies of horizontal light and dark pixel sequencies of different lengths for a further code example, not shown, with a module size 0.82 ppm.

FIG. 11b a histogram with frequencies of vertical light and dark pixel sequences of different lengths for the code example of FIG. 11a;

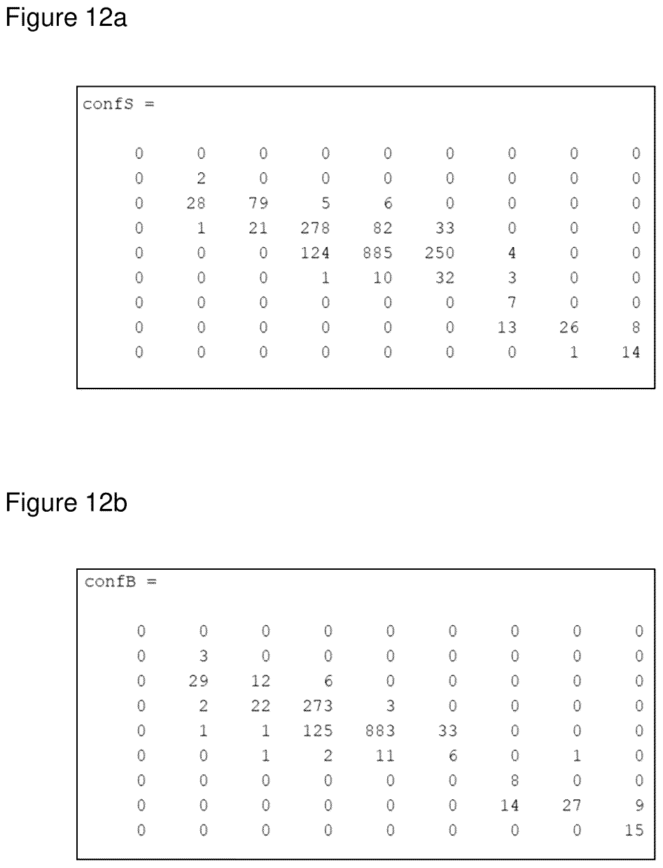

FIG. 12a an exemplary confusion matrix for the estimated module size by means of template matching using light pixel sequences;

FIG. 12b an exemplary confusion matrix for the estimated module size by means of template matching using dark pixel sequences;

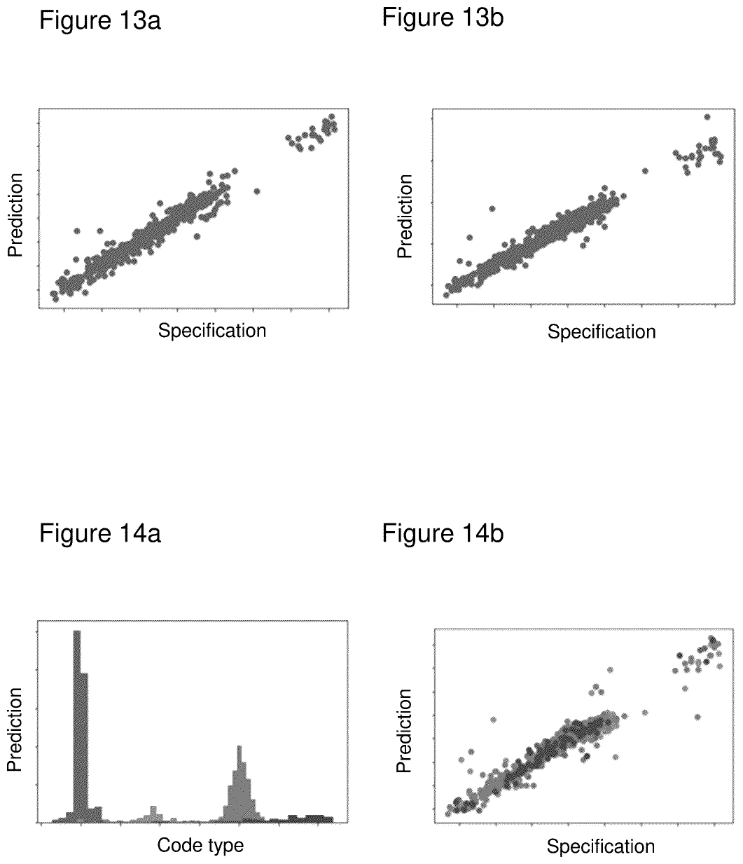

FIG. 13a a comparison between specification (ground truth) and prediction of a neural network for the module size;

FIG. 13b a comparison similar to FIG. 13a for a neural network having fewer neurons in the hidden layers;

FIG. 14a an exemplary prediction of the code type by a neural network; and

FIG. 14b a comparison between specification (ground truth) and prediction of the neural network in accordance with FIG. 14a.

FIG. 1 shows an optoelectronic code reader 10 in a preferred situation of use mounted above a conveyor belt 12 that conveys objects 14, as indicated by the arrow 16, through the detection zone 18 of the code reader 10. The objects 14 bear code zones 20 on their outer surfaces which are detected and evaluated by the code reader 10. These code zones 20 can only be recognized by the code reader 10 when they are affixed to the upper side or at least in a manner visible from above. Differing from the representation in FIG. 1, a plurality of code readers 10 can therefore be installed for the reading from different directions of a code 22 affixed somewhat to the side or to the bottom in order to permit a so-called omnireading from all directions. The arrangement of the plurality of code readers 10 to form a reading system mostly takes place as a reading tunnel in practice. This stationary use of the code reader 10 at a conveyor belt is very common in practice. The invention, however, first relates to the code reader 10 itself and to the method implemented therein for determining a module sized, preferably with a subsequent decoding of codes, so that this example may not be understood as restrictive.

The code reader 10 detects image data of the conveyed objects 14 and of the code zones 20 by a light receiver element 24 and said image data are further processed by a control and evaluation unit 26 by means of image evaluation and decoding processes. It is not the specific imaging process that is important for the invention so that the code reader 10 can be set up in accordance with any principle known per se. For example, only one row is detected in each case, whether by means of a linear image sensor or in a scanning process, with a photodiode as a light reception element 24 being sufficient in the latter case. A direct attempt can be made to read the code from an image line or the control and evaluation unit 26 assembles the rows detected in the course of the conveying movement to form the image data. A larger zone can already be detected in a recording merging a matrix-like image sensor, with the assembly of recordings here also being possible both in the conveying direction and transversely thereto. The plurality of recordings are recorded consecutively and/or by a plurality of code readers 10 whose detection zones 18, for example, only cover the total width of the conveyor belt 12 together, with each code reader so-to-say only recording a tile of the total image and the tiles being assembled by image processing (stitching). An only fragmentary decoding within individual tiles with a subsequent stitching of the code fragments is also conceivable.

The main object of the code reader 10 is to recognize the code zones 20 and to read the codes affixed there. The module size of the respective code 20 is determined as a part step, preferably as early as possible in the processing chain and even before the actual code reading. This will be explained in detail further below with reference to FIGS. 4a to 14b.

The code reader 10 outputs information such as read codes or image data via an interface 28. It is also conceivable that the control and evaluation unit 26 is not arranged in the actual code reader 10, that is in the camera shown in FIG. 1, but is rather connected as a separate control device to one or more code readers 10. The interface 28 then also serves as a connection between an internal and external control and evaluation. The control and evaluation functionality can be distributed practically as desired over internal and external components, with the external components also being able to be connected via a network or cloud. No further distinction will be made of all this here and the control and evaluation unit 26 is understood as part of the code reader 10 independently of the specific implementation.

FIG. 2 shows the control and evaluation unit 26 and its integration in a schematic representation. This representation shows an advantageous embodiment; a control and evaluation unit 26 of any desired internal structure can generally read the image data of the light reception element 24 and process them in the manner still to be described. The control and evaluation unit 26 in the preferred embodiment in accordance with FIG. 2 comprises a first processing unit 30 and a second processing unit 32. The second processing unit 32 preferably has a decoder 36 for reading optical codes using image data. The first processing unit 30 will be explained in the following for the example of an FPGA (field programmable gate array); the second processing unit 32 will be explained in the following for the example of a microprocess or of a CPU (central processing unit). Other and additional digital components, including an embodiment with only one single evaluation component of the control and evaluation unit 26, are likewise possible, including DSPs (digital signal processors), ASIC (application specific integrated circuit), AI processor, NPU (neural processing unit), GPU (graphical processing unit), or the like.

The first processing unit 30 is, on the one hand, connected to the light reception element 24 and, on the other hand, has an interface in the direction of the second processing unit 32, preferably a high speed interface (PCI, PCIE, MIPI). Both processing units 30, 32 can access a memory 34 for image data and additional information, metadata, or processing results. The corresponding reading and writing procedures preferably take place by means of DMA (direct memory access). The memory 34 can be understood at least functionally and, depending on the embodiment, also structurally as part of the second processing unit 32.

In operation, the light reception element 24 now respectively records a new image or a new image section. It can be a rectangular image of a matrix sensor, but individual or multiple image rows of a line sensor are also conceivable that then successively produce a total image in the course of the relative movement between the code reader 10 and the object 14. The image data of the light reception element 24 are read by the first processing unit 30 and is and are transmitted or streamed to the memory 34. In this respect, additional information or metadata is/are preferably determined at the same time, and indeed advantageously on the fly, i.e. directly on the transfer into the memory 34 and still while further image data of the image from the light reception element 24 are to be read or are read. The metadata can relate to different pre-processing that will not be described in any more detail here. For in connection with the invention, in particular the determination of frequency distributions of light or dark pixel sequences of different lengths in preparing for the determination of a module size and possibly the division of an image into tiles and locating regions of interest of an images having codes 20, for example, is of interest. This will be explained below with reference to FIG. 3.

The second processing unit 32 accesses the image data in the memory 34 to further process them. A decoder 36 of the second processing unit 32 particularly preferably reads the content of the optical code 20 recorded with the image data. The second processing unit 32 is additionally able to evaluate metadata stored in the memory 34 by the first processing unit 30. The evaluation of metadata can already take place at least in part in the first processing unit 30; for this reason of the different possible task distributions, this processing step is respectively shown in parentheses in FIG. 2.

FIG. 3 shows an exemplary image with optical codes such as is recorded by the code reader 10. The image is divided into a plurality of tiles 38 in the horizontal and vertical directions, preferably in a uniform grid as shown. Metadata can be determined for each tile 38, for example a mean value or a variance, by which an evaluation can be made whether the respective tile 38 has a structure of interest such as an optical code. At least one respective frequency distribution is determined for the tiles 38 for the determination of the module size in accordance with the invention, in particular in the form of a histogram that represents the possible lengths of light or dark pixel sequences in its bins and that counts how often a pixel sequence of this length occurs in a tile 38 therein. As explained with reference to FIG. 2, such processing steps are possible on the fly during the streaming.

A region of interest 40 having an optical code is determined using metadata and/or further information such as geometrical measurements of an additional sensor. The search for regions of interest 40 can use the metadata addressed in the previous paragraph, but other segmentations are also known. It depends on the image whether there are one or more such regions of interest 40 or possibly no region of interest 40 at all, for instance because the image does not contain any optical codes. In the exemplary image of FIG. 3, still further optical codes can be recognized that are not marked for reasons of clarity. A subset 42 of the tiles 38 corresponds to the region of interest 40. In this respect, a decision is made at the margin, for example using an overlapping portion, whether the tile 38 still belongs to the subset 42 or not. The further process can relate to this subset of tiles 38, to the region of interest 40 determined independently of tiles 38, or to another section having the optical code.

FIG. 4a shows an exemplary tile with a portion of a code. It consists, for example, of 24×24 pixels. The original resolutions can optionally be increased to, for example, 48×48 pixels by means of super-resolution algorithms. FIG. 4b shows the same portion after a binarization, i.e. as a black and white image with only one bit color depth instead of the original grayscale image with, for example, eight bit color depth.

A histogram that counts how often there are light or dark pixel sequences of certain lengths is formed for the determination of the module size as a discrete implementation from such a tile, alternatively from a different image portion with at least parts of the code. Such pixel sequences can extend in any direction in principle, i.e. follow a ling of any direction through the code. Pixel sequences along the horizontal or vertical direction, i.e. rows or columns of the tiles, can be evaluated particularly easily and without discretization artifacts. All the rows and columns should flow in for better statistics, but a partial selection is also possible.

FIGS. 5a-b show such a histogram belong to FIG. 4b with horizontal and vertical pixel sequences respectively. The bins stand for the length of a pixel sequence; the count of each bin for the number of times this length occurs. In this respect, the numbers or frequencies of the light pixel sequences are shown in light gray and of the dark pixel sequences in dark gray; two histograms are thus respectively superposed and a total of four histograms are shown overall in FIGS. 5a-b for the possible combinations of horizontal and vertical and light and dark. This type of compressed representation is maintained in the further Figures with histograms. A light, horizontal pixel sequence of the length two would accordingly be counted in the second bin of the left FIG. 5a in dark gray.

In the example discussed, the bars of the code are oriented almost horizontally. The histogram of FIG. 6a, that counts pixel sequences in the horizontal direction, can therefore not be meaningfully evaluated. The histogram of Figure in contrast, shows clear maxima and no overlong pixel sequences implausible for an optical code. A module size of three to four can be reliably read off from this, namely, on the one hand, from the position of the first maximum or peak; equally from the distance between the peaks, with these criteria being able to support and plausibilize one another. This is not only successful with the naked eye, but equally algorithmically, for example with a threshold evaluation or a function fit. If the starting image was scaled up as in the example (super-resolution, upsampling), the module size can be corrected by the scaling factor and accordingly amounts to 1.5-2.0 ppm. In addition to the module size, the value of the code can even be read that amounts to three in this example because there are three peaks.

Different criteria can be used to decide which histogram is evaluated. Large lengths of pixel sequences can, for example, be cut off above a maximum threshold or the corresponding bins are set to zero. The overlong pixel sequences would thereby be eliminated beyond twelve, for example, in the histogram of FIG. 5a. The histogram generated in an unfavorable direction thus contains a lot fewer events than the other and can be recognized thereby. A histogram having homogeneous surfaces of no interest would also be filtered in this manner. Frequencies below a minimum threshold can be set to zero as a further criterion. The length of a pixel sequence corresponding to the module size should occur very often. Individual events as in FIG. 5a, in contrast, are outliers or due to an unfavorable orientation or to a missing code in the evaluated image section. Using this criterion nothing would remain in the histogram of FIG. 5a so that it is clear that the histogram of FIG. 5b has to be further processed instead. The maximum threshold and the minimum threshold should be set relative to the size of the selected image portion.

Analog to FIGS. 4a-b and 5a-b, FIGS. 6a-b and 7a-b show a different exemplary tile with a portion of a code, the associated binarization, and histograms acquired therefrom in horizontal and vertical directions. This is a negative example with a very small washed out code that furthermore does not fill any full tiles. There is no meaningful result here. The above-discussed criteria will in particular sort out both histograms. A conclusion can even so be drawn that they are small structures. On its own, this can already be valuable for the detector 36 that is positioned downstream and that should therefore use its means to prepare small codes. Whether it is possible with this to still read a code in the extremely poor recording that underlies FIG. 6a, is a different matter; there is at least a chance for this in borderline cases.

Analog to FIGS. 4a-b and 5a-b, FIGS. 8a-b and 9a-b show a different exemplary tile with a portion of a code, the associated binarization, and histograms acquired therefrom in horizontal and vertical directions. This code can again be evaluated better. As already in the example of FIG. 4a, a contrast spread could optionally be carried out before the binarization since the actual grayscale values by no means utilize the possible grayscale values.

In this example, the code is obliquely oriented and both histograms of lines of a horizontal orientation and a vertical orientation enable the further evaluation. The histogram of FIG. 9a shows peaks at 1, 10, and 19; the histogram of FIG. 9b at 4 and 7. The peak at 1 is to be discarded since this peak could admittedly in principle indicate a module width of one, but this is implausible with the distances from the other peaks. A module size of 9-10 thus results in the horizontal direction and a module size of 3-4 in the vertical direction. The different results are not an error since the length of the pixel sequences actually differs in dependence on the orientation of the lines along which they are determined. The decoder located downstream can work with the unadjusted module sizes depending on how the grayscale profiles with which the decoder attempts to read are oriented.

There is additionally the option of determining the orientation of the code within the tile or the image portion or its pixel grid from the different module sizes in the horizontal and vertical directions. If this orientation is defined over its angle α against the horizontal, the absolute or corrected module size is called ModSize, and the horizontally or vertically measured module sizes are called ModSizeₕₒᵣ and ModSizeᵥₑᵣₜ, then

ModSize=cos(α)*ModSizeᵥₑᵣₜ

ModSize=sin(α)*ModSizeₕₒᵣ

tan(α)=ModSizeᵥₑᵣₜ/ModSizeₕₒᵣ

applies.

The orientation can be determined from the third equation and the corrected module size can be determined from the first or second equation using this orientation. It is optionally conceivable to now align the code with the pixel grid using the orientation provided that it is then accepted to read out the image data a further time.

Some examples have thus been presented as to how the module size, optionally also the value and orientation, can be determined from frequency distributions or histograms over lengths of pixel sequences. The first processing unit 30 preferably calculates the histograms per tile 38 and forwards them as metadata via the memory 34 to the second processing unit 32. The regions of interest 40 are determined by a parallel segmentation or by a segmentation carried out in another manner so that subsequently that subset 42 of the tiles 38 can be localized that corresponds to a region of interest 40. The histograms with respect to the tiles 38 can then be added up via the subset 42 for histograms to the region of interest 40.

FIGS. 10a-b and 11a-b show, this time without representation of an underlying starting image, further horizontal and vertical histograms for a module size of 2.31 or 0.82 respectively. The module size and even the value can be robustly determined from the histograms of FIG. 10a using the peaks. The orientation of the codes is here anyway largely vertical; a location of the first peak at 5 can be read off from the associated histogram of FIG. 10b. The estimated module size therefore amounts to 2.5 in good agreement with the actual module size 2.31 due to a resolution increase with a factor of 2.

Clear peaks can likewise be recognized in the histograms of FIGS. 11a-b with respect to the small module size of 0.82. Here, however, the module size of 5 or of rescaled 2.5 read from the histogram in accordance with FIG. 11b would be misleading. This kind of wide peaks in the starting region is not suitable for a direct determination of the module size as in the previous paragraph, for example by selection of peaks by means of threshold evaluation.

In preferred embodiments, more powerful evaluations are therefore used to also do justice to a case such as that of FIG. 11a-b. A template matching and then a neural network are first presented as representatives of a process of machine learning in two examples.

Templates or reference histograms or reference frequency distributions are required for an embodiment with template matching. Training examples for different module sizes and preferably also different code types are collected for this purpose. They can be real images of codes from any desired code reading application and additionally or alternatively artificial images of codes generated from a code content, optionally alienated or printed and read again. If the code content is known from a successful reading, the module size can be retrospectively determined very well. The training examples can therefore be sorted into classes of module sizes, for example [1, 1.5],]1.5, 2], . . . , and optionally separately by code type. Histograms are now formed per class via the training examples of the class. If the counts in the bins of the histograms of a class are now added up and if this is preferably standardized to a total sum of one, the template for this class has thus been found.

In operation, a histogram respectively detected for the current code is preferably first standardized. The difference between this histogram and the different reference histograms is then formed. This difference is a measure of correlation or of similarity, strictly speaking the inverse, namely a measure for the difference or for the error. The histogram and thus the current code are associated with the reference histogram with the smallest error. The estimated module size is that of the associated class.

FIGS. 12a-b show confusion matrices of a template matching, once for dark code elements and once for light code elements, on evaluation of an exemplary dataset with 2D codes. An input takes place for every evaluated code in the confusion matrix at an X position of the actual module sizes and a Y position of the determined module sizes. A perfect template matching would only generate inputs on the diagonal. The confusion matrices shown at least approximate this situation. The code type can also be determined up to a certain degree. Results in this regard can be collected in a similar confusion matrix, which is, however, not shown.

The template matching specifies a certain error corresponding to the size of the classes by its classes; the module size cannot be estimated more accurately in this manner. There are moreover certain difficulties in discovering the total variance of possible code scenarios with reference histograms.

In a further embodiment, a process of machine learning is therefore used instead of template matching, explained here for the example of a neural network. The training examples explained for the template matching can equally be used for a supervised learning of the neural network since in this way a large number of datasets together with an associated correct module size (label, annotation) is available, with a high degree of automation.

It is assumed for reasons of simplicity that the preferred direction of horizontal or vertical is known so that only the two histograms for light and dark code elements form the input data. With a respective 20 bins, an input vector of the neural network of 1×40 results. The neural network can be built up with fully connected layers and a few hidden layers are sufficient. At the output side, only a scaler for the module size is required, possibly a vector with additional output values such as the value or code type.

FIGS. 13a-b respectively show a comparison between the specification (ground truth) and the prediction of the neural network for the module size. In the ideal case, all the points would be located on a straight line with a pitch of one. In FIG. 13a, a neural network with an input layer of 40 neurons, a first hidden layer with 80 neurons, a second hidden layer with 40 neurons, and an output neuron was used. In FIG. 13b, a smaller neural network with only 10 neutrons in the first hidden layer and only 5 neurons in the second hidden layer was used. This reduces the number of weights to be learned from approximately 6000 to 500, with correspondingly lower demands on the training examples and the training time. The predictive force of the smaller normal network is similarly good, at least with the naked eye. An implementation us thus also possible with limited search resources and under real time demands.

FIGS. 14a-b finally illustrate the complementary prediction of the code type on a second output neuron. FIG. 14a shows the four clusters corresponding to the code types C128, ITL25, 2D and PDF41. FIG. 14b is an associated representation of the predicted module sizes over the actual module sizes similar to FIGS. 13a-b, with the points in the same gray shades corresponding to the code type of FIG. 14a being entered. The training dataset used here contained a different number of training examples per code type. This should be taken into account in the training, for example by a preferred training repetition with rarer code types. It is even better to train using a more balanced dataset.

1. A method of determining the module size of an optical code in which image data having the code are recorded and the module size is estimated from distances between light-dark transitions in the image data,
wherein at least one frequency distribution is formed that indicates how often dark and/or light pixel sequences of a respective number occur along at least one line through the code; and wherein the module size is estimated from the frequency distribution.

2. The method in accordance with claim 1,
wherein the at least one frequency distribution is a histogram.

3. The method in accordance with claim 1,
wherein a dark frequency distribution is formed for dark pixel sequences and a light frequency distribution is formed for light pixel sequences.

4. The method in accordance with claim 1,
wherein a horizontal frequency distribution is formed along at least one horizontal line and a vertical frequency distribution is formed along at least one vertical line.

5. The method in accordance with claim 4,
wherein an orientation of the code in the image data is determined by a comparison of a first estimate of the module size from the horizontal frequency distribution and a second estimate of the module size is determined from the vertical frequency distribution.

6. The method in accordance with claim 1,
wherein the module size is corrected by an orientation of the code in the image data.

7. The method in accordance with claim 1,
wherein the at least one frequency distribution is formed along a plurality of mutually parallel lines through the code.

8. The method in accordance with claim 1,
wherein the at least one frequency distribution does not take account of pixel sequences of a number greater than a maximum threshold.

9. The method in accordance with claim 1,
wherein only frequencies above a minimum threshold are taken into account in the at least one frequency distribution.

10. The method in accordance with claim 1,
wherein the module size is determined from a position of a first maximum in the at least one frequency distribution.

11. The method in accordance with claim 1,
wherein a value of the code is determined from the number and/or location of maxima in the at least one frequency distribution.

12. The method in accordance with claim 1,
wherein the module size is determined by a comparison of the at least one frequency distribution with reference frequency distributions for different classes of module sizes.

13. The method in accordance with claim 1,
wherein the module size is determined by evaluating the at least one frequency distribution using a process of machine learning.

14. The method in accordance with claim 13,
wherein the process of machine learning uses a neural network.

15. The method in accordance with claim 12,
wherein the method is taught using training examples with image data or frequency distributions and associated module sizes.

16. The method in accordance with claim 1,
wherein the image data are segmented in a pre-processing to locate an image zone having the code and/or the image data are binarized.

17. The method in accordance with claim 1,
wherein the code is read after the determination of the module size.

18. The method in accordance with claim 17,
wherein the code is read using a decoding process selected with reference to the module size and/or parameterized by the module size.

19. The method in accordance with claim 1,
wherein the module size is only determined binarily as a small or larger module size.

20. The method in accordance with claim 19,
wherein a small module size is below two or below one and a larger module size correspondingly amounting to at least two or at least one.

21. A code reader for reading optical codes that has a light reception element for the detection of image data with the code and a control and evaluation unit that is configured to read the code by a decoding process, and
wherein the control and evaluation unit is configured to determine the module size of the code using a method in which image data having the code are recorded and the module size is estimated from distances between light-dark transitions in the image data, wherein at least one frequency distribution is formed that indicates how often dark and/or light pixel sequences of a respective number occur along at least one line through the code; and wherein the module size is estimated from the frequency distribution.
